(19) United States
(12) Patent Application Publication
(10) Pub. No.: US 2015/0191642 A1
(43) Pub. Date: Jul. 9, 2015

(54) CEMENTING FLUID AND METHODS FOR PRODUCING THE SAME

(71) Applicant: HERCULES INCORPORATED, Wilmington, DE (US)

(72) Inventors: Tuyen T. Nguyen, Newark, DE (US); Cuiyue Lei, Wayne, NJ (US); Hong Yang, Newark, DE (US); Bilal S. Marie, Montclair, NJ (US)

(21) Appl. No.: 14/578,642

(22) Filed: Dec. 22, 2014

Related U.S. Application Data
(60) Provisional application No. 61/924,871, filed on Jan. 8, 2014.

(51) Int. Cl. C09K 8/46; E21B 33/138

(52) U.S. Cl. CPC C09K 8/46; E21B 33/138

(57) ABSTRACT

The presently disclosed and/or claimed inventive concept(s) relates generally to a cementing fluid for use in high temperature wellbore application. More particularly, the presently disclosed and/or claimed inventive concept(s) relates to a cementing fluid comprising an aqueous fluid, a hydraulically-active cementitous material, and a suspending agent, wherein the suspending agent is a high molecular weight hydrophobic copolymer or a cross-linked hydrophobic copolymer particulate. Additionally, the presently disclosed and/or claimed inventive concept(s) relates generally to the methods of making the cementing fluid containing the suspending agent.

### CROSS REFERENCE TO RELATED APPLICATIONS

The present application claims the benefit under 35 U.S.C. 119 (e) of U.S. Provisional Patent Application Ser. No. 61/924,871, filed on Jan. 8, 2014, the entire content of which is hereby expressly incorporated herein by reference.

### BACKGROUND

1. Field of the Invention

The presently disclosed and/or claimed inventive process(es), procedure(s), method(s), product(s), result(s), and/or concept(s) (collectively hereinafter referred to as the “presently disclosed and/or claimed inventive concept(s)”) relates generally to a cementing fluid for use in high temperature wellbore application. More particularly, but not by way of limitation, the presently disclosed and/or claimed inventive concept(s) relates to a cementing fluid comprising an aqueous fluid, a hydraulically-active cementitous material, and a suspending agent, wherein the suspending agent is a hydrophobic copolymer having a weight average molecular weight greater than 10,000 Daltons or a cross-linked hydrophobic copolymer particulate or a hydrophobic copolymer of a vinyl lactam and a polymerizable carboxylate. Additionally, the presently disclosed and/or claimed inventive concept(s) relates generally to the methods of making the cementing fluid containing the above suspending agent.

2. Background of the Invention

A natural resource such as oil or gas residing in a subterranean formation can be recovered by drilling a well into the formation. To do so, a wellbore is typically drilled down to the subterranean formation while circulating a drilling fluid through the wellbore. After the drilling is terminated, a string of pipe, e.g., casing, is run in the wellbore.

Primary cementing operations are then usually performed whereby a cementing fluid, including water, cement, and liquid and/or particulate additives, is pumped down through a string of pipe and into the annulus between the string of pipe and the walls of the wellbore to allow the cementing fluid to set into an impermeable cement column and thereby seal the annulus to create zonal isolation, to provide structural support for casing, and to protect casing from corrosion. Subsequent secondary cementing operations, i.e., any cementing operation after the primary cementing operations, may also be performed. One example of the secondary cementing operations is squeeze cementing whereby a cementing fluid is forced under pressure to areas of lost integrity in the annulus to seal off those areas.

As the circulating temperature of the bottom hole of well increases, the viscosity of the cementing fluid decreases. This decrease in viscosity, which is known as thermal thinning, can result in settling of the solids in the slurry. Undesirable consequences of the solids settling include free water and a density gradient in the set cement. To inhibit settling, cement suspending agents, e.g., cross-linked polymers can be added to the cementing fluid. As the cementing fluid temperature increases, the cement suspending agent should increase the viscosity of the cementing fluid, for example, by breaking cross-links to release a polymer into the fluid. One important feature of the suspending agent is that it does not adversely affect the low-temperature rheology.

Existing suspending agents, e.g., guars or guar derivatives cross-linked with borate, can delay crosslink breakage sufficiently to allow mixing and pumping of a cement fluid without imparting an excessively-high viscosity. However, for a well at depth greater than 5000 ft, the temperature of the well increases and can reach 190° C. or above. Most of additives that work well at lower temperatures will lose the viscosity at this temperature range due to chemical instability or other molecular interactions. Sometimes the viscosity loss can be compensated by using higher amounts of the additives. However, higher additive dosages will cause high viscosity of the mix at the surface. Pumping of the cement becomes difficult when consistency of a mix is higher than 40 BC (Bearden unit of consistency for cement slurry viscosity).

The desired additives should also not cause free water on top of the slurry of cement when it is sitting before cure. Excessive free water on top of the cement column will result in an incompetent zone close to the top of the liner which will have to be remedied with an expensive squeeze job. The viscosity of the slurry describes the rheological behavior of the slurry, which is determined by measuring the plastic viscosity (pv) and the yield point (yp) of the slurry. The cement slurry should be fluid and pumpable until it is in place, then it should start to set as soon as possible after placement. Any delay in the development of compressive strength will increase the “waiting on cement” time (WOC) necessary before proceeding with the next operation. The thickening time (TT) is used to describe the point at which the hardening of the cement has proceeded to such an extent so as to affect the pumping rates.

It has been found that a thermally activated hydrophobically modified alkyl acrylate polymer having the initial viscosity of the slurry lower than 40 BC at room temperature, can provide the adequate cement viscosity (>10 BC) that sustains anti-settling at temperatures above 177° C. The polymer comprises a hydrophobic component and a hydrophilic component. The hydrophobic component renders the polymer insoluble in an aqueous environment at room temperature and soluble when it is exposed to high temperatures. The hydrophobic component can control hydration temperature.

### DETAILED DESCRIPTION OF THE INVENTIVE CONCEPT(S)

Before explaining at least one embodiment of the presently disclosed and/or claimed inventive concept(s) in detail, it is to be understood that the presently disclosed and/or claimed inventive concept(s) is not limited in its application to the details of construction and the arrangement of the components or steps or methodologies set forth in the following description or illustrated in the drawings. The presently disclosed and/or claimed inventive concept(s) is capable of other embodiments or of being practiced or carried out in various ways. Also, it is to be understood that the phraseology and terminology employed herein is for the purpose of description and should not be regarded as limiting.

Unless otherwise defined herein, technical terms used in connection with the presently disclosed and/or claimed inventive concept(s) shall have the meanings that are commonly understood by those of ordinary skill in the art. Further, unless otherwise required by context, singular terms shall include pluralities and plural terms shall include the singular.

All patents, published patent applications, and non-patent publications mentioned in the specification are indicative of the level of skill of those skilled in the art to which the presently disclosed and/or claimed inventive concept(s) pertains. All patents, published patent applications, and non-patent publications referenced in any portion of this application are herein expressly incorporated by reference in their entirety to the same extent as if each individual patent or publication was specifically and individually indicated to be incorporated by reference.

All of the articles and/or methods disclosed herein can be made and executed without undue experimentation in light of the present disclosure. While the articles and methods of the presently disclosed and/or claimed inventive concept(s) have been described in terms of preferred embodiments, it will be apparent to those of ordinary skill in the art that variations may be applied to the articles and/or methods and in the steps or in the sequence of steps of the method described herein without departing from the concept, spirit and scope of the presently disclosed and/or claimed inventive concept(s). All such similar substitutes and modifications apparent to those skilled in the art are deemed to be within the spirit, scope and concept of the presently disclosed and/or claimed inventive concept(s).

As utilized in accordance with the present disclosure, the following terms, unless otherwise indicated, shall be understood to have the following meanings.

The use of the word “a” or “an” when used in conjunction with the term “comprising” may mean “one,” but it is also consistent with the meaning of “one or more,” “at least one,” and “one or more than one.” The use of the term “or” is used to mean “and/or” unless explicitly indicated to refer to alternatives only if the alternatives are mutually exclusive, although the disclosure supports a definition that refers to only alternatives and “and/or.” Throughout this application, the term “about” is used to indicate that a value includes the inherent variation of error for the quantifying device, the method being employed to determine the value, or the variation that exists among the study subjects. For example, but not by way of limitation, when the term “about” is utilized, the designated value may vary by plus or minus twelve percent, or eleven percent, or ten percent, or nine percent, or eight percent, or seven percent, or six percent, or five percent, or four percent, or three percent, or two percent, or one percent. The use of the term “at least one” will be understood to include one as well as any quantity more than one, including but not limited to, 1, 2, 3, 4, 5, 10, 15, 20, 30, 40, 50, 100, etc. The term “at least one” may extend up to 100 or 1000 or more depending on the term to which it is attached. In addition, the quantities of 100/1000 are not to be considered limiting as lower or higher limits may also produce satisfactory results. In addition, the use of the term “at least one of X, Y, and Z” will be understood to include X alone, Y alone, and Z alone, as well as any combination of X, Y, and Z. The use of ordinal number terminology (i.e., “first”, “second”, “third”, “fourth”, etc.) is solely for the purpose of differentiating between two or more items and, unless otherwise stated, is not meant to imply any sequence or order or importance to one item over another or any order of addition.

As used herein, the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps. The term “or combinations thereof” as used herein refers to all permutations and combinations of the listed items preceding the term. For example, “A, B, C, or combinations thereof” is intended to include at least one of: A, B, C, AB, AC, BC, or ABC and, if order is important in a particular context, also BA, CA, CB, CBA, BCA, ACB, BAC, or CAB. Continuing with this example, expressly included are combinations that contain repeats of one or more item or term, such as BB, AAA, MB, BBC, AAABCCCC, CBBAAA, CABABB, and so forth. The skilled artisan will understand that typically there is no limit on the number of items or terms in any combination, unless otherwise apparent from the context.

Also, as used herein, an “alkyl(meth)acrylate” means an alkyl ester of acrylic and/or methacrylic acid.

A cementing fluid of the presently disclosed and/or claimed inventive concept(s) generally comprises, consists of, or consists essentially of an aqueous fluid, a hydraulically-active cementitous material, and a suspending agent. The suspending agent can be a hydrophobic copolymer having a weight average molecular weight greater than 10,000 Daltons or a cross-linked hydrophobic copolymer particulate. The suspending agent can also be a hydrophobic copolymer of a vinyl lactam and a polymerizable carboxylate.

The hydrophobic copolymer having a weight average molecular weight greater than 100,000 Daltons can be produced by solution polymerization of an alkyl(methy)acrylate and an ethylenically unsaturated monomer.

In one non-limiting embodiment of preparing the hydrophobic copolymer having a weight average molecular weight greater than 100,000, reaction solvents and/or partial reactants can be first added into a reactor fitted with heating mantle, reflux condenser, stirrer, nitrogen purging net and outlet. With nitrogen purging and mechanical stirring, the reactants can be heated to a desired temperature. An initiator is added and remaining reactants and/or solvents are fed into the reactor for about 2-6 hours. Reaction can be continued and more initiators can be added. When the residual reactant is lower than about 1000 ppm, the reactor can be cooled to about 50° C. and product can be discharged.

The alkyl (meth)acrylate can contain a straight or branched alkyl group of about 1 to about 22 carbon atoms per group. Examples of the alkyl group can include, but are not limited to, n-propyl, isopropyl, n-butyl, isobutyl, tert-butyl, n-pentyl, isopentyl, n-hexyl, n-heptyl, iso-norbornyl, n-dodecyl, t-dodecyl, n-tetradecyl , n-hexadecyl, n-octadecyl, and n-eicosyl.

The ethylenically unsaturated monomers can be acrylamide, N-substituted and N,N′-disubstituted acrylamides (N,N′-dimethyl acrylamide), N-vinylamides and N-alkyl-N-vinylamides, sodium 2-acrylamido-2-methylpropanesulfonate, 2-acrylamido-2-methylpropanesulfonic acid, N-(hydroxymethyl)acrylamide, N-(hydroxyethyl)acrylamide, methacrylamide, N-vinylformamide, 1-vinyl-2-pyrrolidinone, N-vinylcaprolactam, N-acryloyl morpholine, N-methyl-N-vinylacetamide, N-isopropylacrylamide, N,N-diethylacrylamide, sodium 4-styrenesulfonate, styrene, styrene sulfonte, vinyl sulfonate, vinyl pyrrolidone, vinyl acetate, vinyl benzene, ally-2-hydroxypropane sulfonate, vinyl propionate, and any derivative thereof.

The solvent used for the solution polymerization can be water, methanol, ethanol, isopropanol, tert-butanol, isopropyl acetate, toluene, benzene and/or mixture thereof. Polymerization temperature can be ranged from about 50° C.-90° C.

Compounds capable of initiating the free-radical polymerization can be used as the initiators in the presently disclosed and/or claimed inventive concept(s). The compounds can be peroxo and azo classes of materials. Peroxo and azo compounds can include, but are not limited to, acetyl peroxide; azo bis-(2-amidinopropane)dihydrochloride; azo bis-isobutyronitrile; 2,2′-azo bis-(2-methylbutyronitrile); benzoyl peroxide; di-tert-amyl peroxide; di-tert-butyl diperphthalate; butyl peroctoate; tert-butyl dicumyl peroxide; tert-butyl hydroperoxide; tert-butyl perbenzoate; tert-butyl permaleate; tert-butyl perisobutylrate; tert-butyl peracetate; tert-butyl perpivalate; para-chlorobenzoyl peroxide; cumene hydroperoxide; diacetyl peroxide; dibenzoyl peroxide; dicumyl peroxide; didecanoyl peroxide; dilauroyl peroxide; diisopropyl peroxodicarbamate; dioctanoyl peroxide; lauroyl peroxide; octanoyl peroxide; succinyl peroxide; and bis-(ortho-toluoyl)peroxide.

Other suitable initiators of the free-radical polymerization are initiator mixtures or redox initiator systems, which can include, but are not limited to, ascorbic acid/iron (II) sulfate/sodium peroxodisulfate, tert-butyl hydroperoxide/sodium disulfite, and tert-butyl hydroperoxide/sodium hydroxymethanesulfinate. Particularly, the initiators used in the presently/or and claimed inventive concept(s) can be commercially available Trigonox® and/or Vazo® initiators.

Initiator mixtures or redox initiator systems can also include, but are not limited to, ascorbic acid/iron (II) sulfate/sodium peroxodisulfate, tert-butyl hydroperoxide/sodium disulfite, and tert-butyl hydroperoxide/sodium hydroxymethanesulfinate.

The hydrophobic copolymer of a vinyl lactam and a polymerizable carboxylate can be prepared using any known polymerization methods, which can include, but are not limited to solution polymerization and precipitation polymerization.

The vinyl lactam can be vinyl pyrrolidone or vinyl caprolactam. The polymerizable carboxylate can be acrylates or alkyl methacrylates. In one non-limiting embodiment, the copolymer of the vinyl lactam and the polymerizable carboxylate can be synthesized by solution polymerization as shown in Formula (I). The solution polymerization process is the same as those described previously. The initiator and solvent are also the same as those described previously.

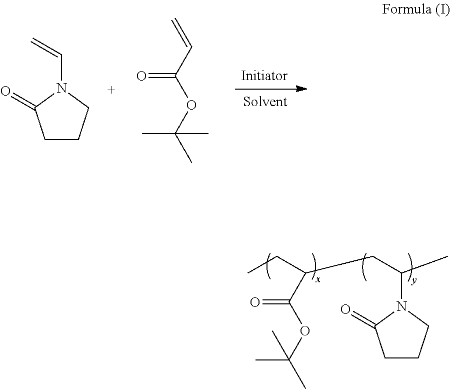

In Formula (I), each x and y is an independently selected integer ranging from 1 to about 500,000. In one non-limiting embodiment, each x and y is an independently selected integer ranging from about 10 to about 100,000. In another non-limiting embodiment, each x and y is an independently selected integer ranging from about 100 to about 50,000.

The hydrophobically modified polymer of vinyl pyrrolidone and polymerizable carboxylate can be made by polymerizing N-Vinyl pyrrolidone (VP) from about 0.1 wt % to about 99.9 wt % and tert-butyl acrylate (TBA) from about 0.1 wt % to about 99.9 wt %. In one non-limiting embodiment, the polymer can be made by polymerizing from about 20% by weight to about 80% by weight of N-vinyl-2-pyrrolidone and from about 20% by weight to about 90% by weight of tert-butyl acrylate (TBA). In another non-limiting embodiment, the polymer can be made by polymerizing from about 30% by weight to about 60% by weight of N-vinyl-2-pyrrolidone and from about 40% by weight to about 70% by weight of Tert-butyl acrylate (TBA). The weight % values of constituent monomers for each polymer are such that their sum for each polymer equals 100.

The weight average molecular weight of the polymers prepared can range from 1,000 to 3,000,000 Daltons (Da) by Size-exclusion Chromatography (SEC), more particularly from about 5,000 Da to about 1,000,000 Da, and even more particularly from about 20,000 Da to about 500,000 Da.

The cross-linked hydrophobic copolymer particulate can be produced by emulsion copolymerizing a reaction mixture to form a hydrophobic copolymer in the presence of an emulsifier and cross-linking the hydrophobic copolymer using a cross-linker. The reaction mixture comprises an alkyl (meth)acrylate and a non acrylate monomer. The non-acrylate monomer can be any ethylenically unsaturated monomer except for acrylate monomer.

The cross-linker for use in the presently disclosed and/or claimed inventive concept(s) may be a cross-linker with at least two vinyl or vinylidene groups that form at least one crosslink that is hydrolytically stable at ambient temperature and hydrolytically unstable at high temperature, i.e., above 107° C., on the timescale of the well treatment. As used herein, “hydrolytically stable,” and any derivative thereof, indicates stable against hydrolysis. Examples of the cross-linkers can include, but are not limited to, ethylene bisacrylate, polyethylene glycol diacrylate (2 to 30 units), pentaerythritol tetraacrylate, ethoxylated pentaerythtritol tetraacrylate, trimethylolpropane triacrylate, ethoxylated trimethylolpropane triacrylate, glycerol triacrylate, ethoxylated glycerol triacrylate, pentaerythtritol diacylate monostearate, pentaerythtritol triacrylate, penterythritol propoxylate triacrylate, pentaerythritol tetraacrylate, pentaerythritol triallyl ether, pentaerythritol dially ether, pentarythrytol teterally ether, N,N′-methylene bisacrylamide, N,N′-ethylene bisacrylamide, N′N′-hexamethylene bisacrylamide, N, N′-(1,2-dihydroxyethylene) bisacrylamide, N,N′-cystaminebisacrylamide, diallyl ether, diallyl bisphenol A, diallyl maleate, diallyl oxyacetic acid sodium salt, diallylphthalate, diallyl succinate, diallyl urea, triallyl amine, triallylcyanurate, triallyl-1,3,5-triazine 2,4,6-trione, 2,4,6-triallyloxy-1,3,5 triazine, triallyl trimeliitate, tribally 1,3,5 benzenetricarboxylate, and allyl ether.

The cross-linker may be present in the reaction to form a cross-linked particulate in an amount ranging from a lower limit of about 0.1%, 0.5%, 1%, 5%, or 10% by weight of total monomer to an upper limit of about 20%, 15%, 10%, 5%, 1% by weight of total monomer, and wherein the amount may range from any lower limit to any upper limit and encompass any subset between the upper and lower limits.

The polymerization techniques used to prepare the emulsion copolymer of the presently disclosed and/or claimed inventive concept(s) are well known in the art. Conventional emulsifiers may be used, such as, for example but by no way of limitation, anionic and/or nonionic emulsifiers. Examples of emulsifiers can include, but are not limited to, alkali metal or ammonium salts of alkyl, aryl, or alkylaryl sulfates, sulfonates or phosphates; alkyl sulfonic acids; sulfosuccinate salts; fatty acids; ethylenically unsaturated surfactant monomers; and ethoxylated alcohols or phenols. The amount of emusifier used can be 0.1% to 6% by weight, based on the weight of monomer.

The polymerization can be carried out using conventional emulsion polymerization catalysts. Examples of the catalyst can include, but are not limited to, peroxides, persulfates, and azo compounds such as sodium persulfate; potassium persulfate, ammonium persulfate, hydrogen peroxide, t-butyl hydroperoxide, cumene hydroperoxide, azodiisobutyric diamide as well as redox catalysts activated in the water phase by a water-soluble reducing agent. Typically, such catalysts are employed in an amount ranging from 0.01 to 5 weight percent based upon the monomer weight.

The polymerization temperature can be maintained at a temperature lower than 100° C. throughout the course of the polymerization. In one non-limiting embodiment, the polymerization temperature can be between 30° C. and 95° C. In another non-limiting embodiment the polymerization temperature can be between 50° C. and 90° C. The monomer mixture may be added neat or as an emulsion in water. The monomer mixture may be added in one or more additions or continuously, linearly or not, over the reaction period, or combinations thereof. The polymerization can be carried out at pH of about 4 to about 8.

Conventional chain transfer agents such as n-dodecyl mercaptan, bromoform, and carbon tetrachloride can also be employed in the normal fashion to regulate the molecular weight of the polymer. Typically, such chain transfer agents are used in amounts ranging from 0.01 to 5 weight percent based on the weight of the monomer. In one non-limiting embodiment, the chain transfer agents can be used in amounts ranging from 0.1 to 1 by weight percent based on the weight of the monomer.

The hydrophobic copolymer in the presently disclosed and/or claimed inventive concept(s) may be in liquid form or any particulate suitable for use in a subterranean formation including, but not limited to, cementitious particulates, weighting agents, proppants, fine aggregate particulates, and any combination thereof. It should be understood that the term “particulate” or “particle,” as used in the presently disclosed and/or claimed inventive concept(s), includes all known shapes of materials, including, but not limited to, spherical materials, substantially spherical materials, low to high aspect ratio materials, fibrous materials, polygonal materials (such as cubic materials), and mixtures thereof.

The particulates for use in the presently disclosed and/or claimed inventive concept(s) may have a diameter ranging from a lower limit of about 0.5 μm, 1 μm, 10 μm, 50 μm, 0.1 mm, or 1 mm to an upper limit of about 10 mm, 1 mm, 0.5 mm, 0.1 mm, or 50 μm, and wherein the diameter may range from any lower limit to any upper limit and encompass any subset between the upper and lower limits. A particulate may be present in a cementing fluid in an amount ranging from a lower limit of about 10%, 20%, 30%, 40%, or 50% by weight of cementing fluid to an upper limit of about 90%, 80%, 70%, 60%, 50%, or 40% by weight of cementing fluid, and wherein the amount may range from any lower limit to any upper limit and encompass any subset between the upper and lower limits.

The terms “cementitous material”, “cement”, “hydraulically-active cementitous material” and “hydraulic cement” may be used interchangeably in this application. As used herein, the terms refer to compounds of a cementitious nature that set and/or harden in the presence of water. Suitable hydraulic cements for use in the presently disclosed and/or claimed inventive concept(s) may be any known hydraulic cement including, but are not limited to, a Portland cement including API classes A, B, C, G, and H; a slag cement; a pozzolana cement; a gypsum cement; an aluminous cement; a silica cement; a high alkalinity cement; and any combination thereof.

Suitable aqueous fluids for use in the presently disclosed and/or claimed inventive concept(s) may comprise fresh water, saltwater (e.g., water containing one or more salts dissolved therein), brine (e.g., saturated salt water), seawater, and any combination thereof. Generally, the water may be from any source, provided that it does not contain components that might adversely affect the stability and/or performance of the compositions or methods of the presently disclosed and/or claimed inventive concept(s).

Suitable weighting agents for use in the presently disclosed and/or claimed inventive concept(s) may be any known weighting agent that is a particulate including, but not limited to, barite; hematite; manganese tetraoxide; galena; silica; siderite; celestite; ilmenite; dolomite; calcium carbonate; and any combination thereof.

Suitable proppants for use in the presently disclosed and/or claimed inventive concept(s) may be any known proppant including, but not limited to, sand, bauxite, ceramic materials, glass materials, polymer materials, polytetrafluoroethylene materials, nut shell pieces, cured resinous particulates comprising nut shell pieces, seed shell pieces, cured resinous particulates comprising seed shell pieces, fruit pit pieces, cured resinous particulates comprising fruit pit pieces, wood, composite particulates, and any combination thereof. Suitable composite particulates may comprise a binder and a filler material wherein suitable filler materials include silica, alumina, fumed carbon, carbon black, graphite, mica, titanium dioxide, meta-silicate, calcium silicate, kaolin, talc, zirconia, boron, fly ash, hollow glass microspheres, solid glass, and any combination thereof.

Suitable fine aggregate particulates for use in the presently disclosed and/or claimed inventive concept(s) may include, but are not limited to, fly ash, silica flour, fine sand, diatomaceous earth, lightweight aggregates, hollow spheres, and any combination thereof.

While a number of preferred embodiments described herein relate to cementing fluids, it is understood that other cementing fluids may also be prepared according to the presently disclosed and/or claimed inventive concept(s) including, but not limited to, spacer fluids, drilling fluids, fracturing fluids, and lost circulation fluids. As referred to herein, the term “spacer fluid” should be understood to mean a fluid placed within a wellbore to separate fluids, e.g., to separate a drilling fluid within the wellbore from a cementing fluid that will subsequently be placed within the wellbore.

In some embodiments, the suspending agent may be included in a first fluid that is placed in a wellbore and/or subterranean formation before and/or after a second fluid, wherein the second fluid comprises a plurality of particulates and the suspending agent. In some embodiments, the concentration of suspending agent may be different in a first fluid than in a second fluid. In some embodiments, the first fluid may be a spacer fluid and the second fluid may be a cementing fluid.

The teachings of the presently disclosed and/or claimed inventive concept(s) and the methods and compositions of the presently disclosed and/or claimed inventive concept(s) may be used in many different types of subterranean treatment operations.

Such operations include, but are not limited to, casing operations, plugging operations, drilling operations, lost circulation operations, completion operations, and water-blocking operations. In some embodiments, the suspending agent of the presently disclosed and/or claimed inventive concept(s) may be used as a secondary gelling agent in a high-temperature fracturing treatment. The methods and compositions of the presently disclosed and/or claimed inventive concept(s) may be used in large-scale operations or pills. As used herein, a “pill” is a type of relatively small volume of specially prepared treatment fluid placed or circulated in the wellbore.

In some embodiments, a suspending agent may be used in a wellbore and/or subterranean formation with a bottom hole static temperature (BHST) ranging from a lower limit of about 107° C., 135° C., 149° C., 163° C., 177° C., 204° C., 232° C. to an upper limit of about 371° C., 343° C., 316° C., 288° C., 260° C., 232° C., 204° C., and wherein the temperature may range from any lower limit to any upper limit and encompass any subset between the upper and lower limits.

In some embodiments, a suspending agent may be provided in wet or dry form. In some embodiments, a suspending agent may be added to a cementing fluid on-site or off-site of the wellbore location.

In some embodiments, a suspending agent may be produced by providing an oil solution comprising an oil-based solvent and a surfactant; providing a monomer mixture comprising an aqueous liquid and the monomers and the cross-linkers needed for a desired cross-linked particulate; forming an inverse suspension with the monomer mixture and the oil solution; and reacting a free-radical initiator with the monomer mixture in the inverse suspension to form a cross-linked particulate. In some embodiments, a cross-linked particulate may be isolated by a method including, but not limited to, drying either by water-miscible solvent extraction or azeotropic distillation; followed by filtration or centrifugation to remove the oil-based solvent. Alternatively, the cross-linked particulate may be isolated from the oil-based solvent before drying with air. One skilled in the art, with the benefit of this disclosure, will recognize suitable procedural variations, including order of addition, to achieve the desired cross-linked particulate. For example, when reacting the free radical initiator with the monomer mixture, the free radical initiator may be added to the monomer mixture shortly before forming the inverse emulsion, to the oil solution before forming the inverse suspension, to the inverse suspension, or any combination thereof.

Suitable oil-based solvents may include, but are not limited to, paraffinic hydrocarbons, aromatic hydrocarbons, olefinic hydrocarbons, petroleum distillates, synthetic hydrocarbons, and any combination thereof. Examples of a suitable oil-based solvent include ESCAID™ (low viscosity organic solvent, available from ExxonMobil, Houston, Tex.). Suitable surfactants may include, but are not limited to, a HYPERMER™. (a nonionic, polymeric surfactant, available from Croda, Edison, N.J.), block copolymers of ethylene oxide and propylene oxide, block copolymers of butylene oxide and ethylene oxide, sorbitan esters, copolymers of methacrylic acid and C₁₂-C₁₈ alkyl methacrylates, alkylarylsulfonate salts, and any combination thereof. Suitable free radical initiators may be any water-soluble free radical initiator including, but not limited to, persulfate salts, organic peroxides, organic hydroperoxides, azo compounds (e.g. 2,2′-azobis(2-amidinopropane)dihydrochloride), and any combination thereof. One skilled in the art with the benefit of this disclosure will recognize the plurality of applicable oil-based solvents, surfactants, and free radical initiators and the appropriate concentrations of each needed for producing a cross-linked particulate.

The following examples illustrate the presently disclosed and/or claimed inventive concept(s), parts and percentages being by weight, unless otherwise indicated. Each example is provided by way of explanation of the presently disclosed and/or claimed inventive concept(s), not limitation of the presently disclosed and/or claimed inventive concept(s). In fact, it will be apparent to those skilled in the art that various modifications and variations can be made in the presently disclosed and/or claimed inventive concept(s) without departing from the scope or spirit of the invention. For instance, features illustrated or described as part of one embodiment, can be used on another embodiment to yield a still further embodiment. Thus, it is intended that the presently disclosed and/or claimed inventive concept(s) covers such modifications and variations as come within the scope of the appended claims and their equivalents.

### EXAMPLES

### Synthesis of Suspending Agents

### Example 1

### T-butylacrylate Polymer

Mixture A of t-butyl acrylate (TBA, 200 g, 1.56 mol), Dowfax® (5 g, available from Dow Chemical Company) and water (72 g) was made under nitrogen atmosphere and continuous stirring. Into a reactor, equipped with a stirrer, under nitrogen atmosphere, Dowfax® (5 g), sodium persulfate (2 g, 8 mmol), Mixture A (54 g), ammonium sulfate (20 g), and water (580 g) were added. The reactor contents were then heated to about 66° C., (150.8° F.) , with stirring (300 rpm) for about 1 hr. The rest of Mixture A was pumped into the reactor for about 1 hr. At this point, a solution of 0.5 g of sodium persulfate in about 50 g of water was added to the reactor. The reactor was kept at about 66° C. for about 30 min. Another catalyst mixture of sodium persulfate (0.36 g) and sodium bicarbonate (0.6 g) in water (20 g) was added. The reaction was continued for about 1 hr after the addition of 2 mL. of 10% sodium bisulfate solution. This product had a Brookfield viscosity of 6 cps at 21% active solid content.

### Example 2

### T-butylacrylate/hexyl acrylate Copolymer

Mixture A of t-buty acrylate (TBA, 150 g, 1.17 mol), hexylacrylate (50 g, 0.32 mol), Dowfax® (5 g) and water (72 g) was made under nitrogen atmosphere and continuous stirring. Into a reactor, equipped with a stirrer, under nitrogen atmosphere, Dowfax® (5 g), sodium persulfate (2 g, 8 mmol), Mixture A (54 g), ammonium sulfate (20 g) and water (580 g) were added. The reactor content was heated to about 66° C., with stirring (300 rpm) for about 1 hr. Then the rest of Mixture A was pumped into the reactor for about 1 hr. At this point, a solution of about 0.5 g of sodium persulfate in about 50 g of water was added to the reactor. The reactor was kept at 66° C. for about 30 min. Another addition of catalyst mixture of sodium persulfate (0.36 g) and sodium bicarbonate (0.6 g) in water (20 g) was added. The reaction was continued for about 1 hr till the addition of 2 mL of 10% sodium bisulfate solution. This product had a Brookfield viscosity of 4 cps at 21% active solid content.

### Example 3

### T-butylacrylate/Sodium 2-acrylamido-2-methylpropane Sulfonate/allyl pentaerythrytyl Ether

Mixture A of t-butyl acrylate (TBA, 80 g, 0.61 mol), sodium laurylsulfate (2 g), 2-acrylamido 2 methylpropane sulfonate salt (2.5 g, 0.006 mol), allyl pentaerythrytyl ether (0.07 g, 0.0005 mol) and water (15 g) was prepared under nitrogen atmosphere and continuous stirring. Into a reactor, equipped with a stirrer, under nitrogen atmosphere, sodium laurylsulfate (0.7 g), Brij® 700 (5 g, available from Croda Inc.), sodium persulfate (1 g, 4 mmol), Mixture A (27 g), and water (258 g) were added. The reactor content was heated to about 60° C. (140 ° F.), with stirring (300 rpm) for about 1 hour, and then the rest of the Mixture A was pumped in for about 1 hr. At this point, a solution of about 0.5 g of sodium persulfate in about 50 g of water was added to the reactor. The reactor was kept at about 66° C. for about 30 min. Another addition of catalyst mixture sodium persulfate (0.18 g) and sodium bicarbonate (0.36 g) in water (8 g) was added. The reaction was continued for about 1 hr till the addition of 1 mL of 10% sodium bisulfate solution. This product had a Brookfield viscosity of 10 cps at 21% solid.

### Example 4

### T-butylacrylate/Sodiumvinylsulfonate (SVS)

Mixture A of t-butyl acrylate (TBA, 80 g, 0.61 mol), sodium laurylsulfate (5 g), vinyl sulfonic acid sodium salt (4.3 g, 0.03 mol), allyl pentaerythrytyl ether (0.14 g, 0.001 mol) and water (40 g) was prepared under nitrogen atmosphere and continuous stirring. Into a reactor, equipped with a stirrer, under nitrogen atmosphere, sodium laurylsulfate (5 g), Brij® 700 (11.2 g, 0.011 mo), sodium persulfate (2 g, 8 mmol), Mixture A (54 g) and water (515) g were added. The reactor content was heated to about 70° C. (158° F.), with stirring (300 rpm) for about 1 hr. then the rest of the Mixture A and sodium persulfate (0.4 g), sodium bicarbonate (0.7 g) in 16 g of water were pumped in for about 1 hr. The reactor was kept at about 70° C. for about 60 min. The reaction was continued for 1 hr after the addition of about 2 mL of 10% sodium bisulfate solution. This product had a Brookfield viscosity of 4 cps.

### Example 5

### T-butylacrylate/N-Vinylpyrrolidone (NVP)

Mixture A of t-butyl acrylate (TBA, 120 g, 0.93 mol), 1-vinyl-2-pyrrolidinone (20 g, 0.28 mol), sodium laurylsulfate (4 g), vinyl sulfonic acid sodium salt (4.3 g, 0.03 mol), ally pentaerythrytyl ether (0.14 g, 0.001 mol) and water (40 g) was prepared under nitrogen atmosphere and continuous stirring. Into a reactor, equipped with a stirrer, under nitrogen atmosphere, sodium laurylsulfate (1.4 g), Brij® 700 (11.2 g, 0.011 mol), sodium persulfate (2 g, 8 mmol), Mixture A (54 g) and water (515 g) were added. The reactor content was heated to about 70° C., with stirring (300 rpm) for about 1 hour, and then the rest of the Mixture A and sodium persulfate (0.4 g), sodium bicarbonate (0.76 g) in 20 g of water were pumped in for about 1 hr. The reactor was kept at about 70° C. for about 60 min. The reaction was continued for about 1 hr after the addition of 2 mL of 10% sodium bisulfate solution. This product had a Brookfield viscosity of 10 cps.

### Example 6

### T-butylacrylate/11-Allyloxyl 2-hydroxylpropyl Sulfonate Sodium Salt (AHPS)

Mixture A of t-butyl acrylate (TBA, 160 g, 1.25 mol), 1-allyloxy 2-hydroxyl propyl sulfonate (20 g, 0.28 mol), sodium laurylsulfate (4 g), vinyl sulfonic acid sodium salt (4.3 g, 0.03 mol), allyl pentaerythrytyl ether (0.14 g, 0.001 mol) and water (40 g) was prepared under nitrogen atmosphere and continuous stirring. Into a reactor, equipped with a stirrer, under nitrogen atmosphere, sodium laurylsulfate (1.4 g), Brij® 700 (11.2 g, 0.011 mo), sodium persulfate (2 g, 8 mmol), Mixture A (54 g) and water (515 g) were added. The reactor content was heated to about 70° C., with stirring (300 rpm) for about 1 hour, and then the rest of the Mixture A and sodium persulfate (0.4 g), sodium bicarbonate (0.76 g) in 20 g of water were pumped in for about 1 hr. The reactor was kept at about 70° C. for about 60 min. The reaction was continued for about 1 hr after the addition of about 2 mL of 10% sodium bisulfate solution. This product had a Brookfield viscosity of 10 cps.

### Example 7

### T-butylacrylate/Sodiumvinylsulfonate/Acrylamide

Mixture A of t-butyl acrylate (TBA, 60 g, 0.47 mol), acrylamide (10 g, 0.14 mol), sodium laurylsulfate (2 g), vinyl sulfonic acid sodium salt (8.6 g, 0.06 mol), allyl pentaerythrytyl ether (0.07 g, 0.5 mmol) and water (11 g) was prepared under nitrogen atmosphere and continuous stirring. Into a reactor, equipped with a stirrer, under nitrogen atmosphere, sodium laurylsulfate (1.4 g), Brij® 700 (5.6 g, 5 mmol), sodium persulfate (1 g, 4 mmol), Mixture A (27 g) and water (250 g) were added. The reactor content was heated to about 70° C., with stirring (300 rpm) for about 1 hour, and then the rest of the Mixture A, sodium persulfate (0.2 g) and sodium bicarbonate (0.0.38 g) in 20 g of water were pumped in for about 1 hr. The reactor was kept at about 70° C. for about 60 min. The reaction was continued for about 1 hr after the addition of 2 mL of 10% sodium bisulfate solution. This product had a Brookfield viscosity of 80 cps.

### Example 8

### lsonorborny methacrylate/Sodiumvinylsulfonate/Acrylamide

Mixture A of isobornyl methacrylate (BMA, 160 g, 072 mol), sodium laurylsulfate (8 g), vinyl sulfonic acid sodium salt (4.3 g, 0.03 mol), ally pentaerythrytyl ether (0.14 g, 0.001 mol) and water (40 g) was prepared under nitrogen atmosphere and continuous stirring. Into a reactor, equipped with a stirrer, under nitrogen atmosphere, sodium laurylsulfate (1.4 g), Brij® 700 (11.2 g, 0.011 mol), sodium persulfate (2 g, 8 mmol), Mixture A (54 g) and water(515 g) were added. The reactor content was heated to about 70° C., with stirring (200 rpm) for about 1 hour, and then the rest of the Mixture A and sodium persulfate (0.4 g), sodium bicarbonate (0.76 g) in 20 g of water were pumped in for about 1 hr. The reactor was kept at about 70° C. for about 60 min. The reaction was continued for 1 more hr after the addition of 2 mL of 10% sodium bisulfate solution. This product had a Brookfield viscosity of 6 cps.

### Example 9

### lsonorbornyl Methacrylate/Sodiumvinylsulfonate/Acrylamide

Mixture A of isobornyl methacrylate (IBMA, 160 g, 0.72 mol), acrylamide (10 g, 0.14 mol), sodium laurylsulfate (8 g), vinyl sulfonic acid sodium salt (4.3 g, 0.03 mol), allyl pentaerythrytyl ether (0.14 g, 0.001 mole) and water (40 g) was prepared under nitrogen atmosphere and continuous stirring. Into a reactor, equipped with a stirrer, under nitrogen atmosphere, sodium laurylsulfate (1.4 g), Brij® 700 (11.2 g, 0.011 mol), sodium persulfate (2 g, 8 mmol), Mixture A (54 g) and water (515 g) were added. The reactor content was heated to about 70° C., with stirring (200 rpm) for about 1 hour, and then the rest of the mixture A and sodium persulfate (0.4 g), sodium bicarbonate (0.76 g) in 20 g of water were pumped in for about 1 hr. The reactor was kept at about 70° C. for about 60 min, The reaction was continued for about 1 hr after the addition of 2 mL of 10% sodium bisulfate solution. This product had a Brookfield viscosity of 60 cps.

### Example 10

### Isobutylacrylate/Sodiumvinylsulfonate/Acrylamide

Mixture A of isobutyl acrylate (ISBA, 160 g, 0.72 mol), acrylamide (10 g, 0.14 mol), sodium laurylsulfate (8 g), vinyl sulfonic acid sodium salt (4.3 g, 0.03 mol), ally pentaerythrytyl ether (0.14 g, 0.001 mol) and water (40 g) was prepared under nitrogen atmosphere and continuous stirring. Into a reactor, equipped with a stirrer, under nitrogen atmosphere, sodium laurylsulfate (1.4 g), Brij® 700 (11.2 g, 0.011 mol), sodium persulfate (2 g, 8 mmol), Mixture A (54 g) and water (515 g) were added. The reactor content was heated to about 70° C., with stirring (200 rpm) for about 1 hour, and then the rest of the Mixture A, sodium persulfate (0.4 g) and sodium bicarbonate (0.76 g) in 20 g of water were pumped in for about 1 hr. The reactor was kept at about 70° C. for about 60 min. The reaction was continued for about 1 hr after the addition of 2 mL of 10% sodium bisulfate solution. This product had a Brookfield viscosity of 60 cps.

### Example 11

### Isobutylacrylate/Sodium Vinylsulfonate

Mixture A of isobutyl acrylate (ISBA, 160 g, 1.24 mol), sodium laurylsulfate (8 g), vinyl sulfonic acid sodium salt (4.3 g, 0.03 mol), allyl pentaerythrytyl ether (0.14 g, 0.001 mol) and water (40 g) was prepared under nitrogen atmosphere and continuous stirring. Into a reactor, equipped with a stirrer, under nitrogen atmosphere, sodium laurylsulfate (1.4 g), Brij® 700 (11.2 g, 0.011 mol), sodium persulfate (2 g, 8 mmol), Mixture A (54 g), and water (515 g) were added. The reactor content was heated to about 70° C., with stirring (200 rpm) for about 1 hr, and then the rest of the Mixture A, sodium persulfate (0.4 g) and sodium bicarbonate (0.76 g) in 20 g of water were pumped in for about 1 hr. The reactor was kept at about 70° C. for about 60 min. The reaction was continued for about 1 hr after the addition of 2 mL of 10% sodium bisulfate solution. This product had a Brookfield viscosity of 10 cps.

### Example 12

### T-butylacrylate/lsobornyl methacrylate/Sodiumvinylsulfonate

Mixture A of isobutyl acrylate (ISBA, 20 g, 0.09 mol), t-butylacrylate (140 g,1.09 mol), sodium laurylsulfate (8 g), vinyl sulfonic acid sodium salt (4.3 g, 0.03 mol), ally pentaerythrytyl ether (0.14 g, 0.001 mol) and water (40 g) was prepared under nitrogen atmosphere and continuous stirring. Into a reactor, equipped with a stirrer, under nitrogen atmosphere, sodium laurylsulfate (1.4 g), Brij® 700 (11.2 g, 0.011 mol), sodium persulfate (2 g, 8 mmol), Mixture A (54 g) and water (515 g) were added. The reactor content was heated to about 70° C., with stirring (200 rpm) for about 1 hour, and then the rest of the Mixture A, sodium persulfate (0.4 g) and sodium bicarbonate (0.76 g) in 20 g of water were pumped in for about 1 hr. The reactor was kept at about 70° C. for about 60 min. The reaction was continued for about 1 hr after the addition of 2 mL of 10% sodium bisulfate solution. This product had a Brookfield viscosity of 10 cps.

### Example 13

### T-Butylacrylate/Acrylamide/N,N′dimethylacrylamide/Sodiumvinylsulfonate

Mixture A of t-butylacrylate (160 g, 1.25 mol), vinyl sulfonic acid sodium salt (4.3 g, 0.03 mol), N,N′ dimethylacrylamide (40 g, 0.40 mol), acrylamide (5 g, 0.07 mol), allyl pentaerythrytyl ether (0.2 g, 0.001 mol), Dowfax (5 g), and water (40 g) was prepared under nitrogen atmosphere and continuous stirring. Into a reactor, equipped with a stirrer, under nitrogen atmosphere, Dowfax (5 g), sodium persulfate (2 g, 8 mmol), Mixture A (54 g), ammonium sulfate (20 g) and water (580 g) were added. The reactor content was heated to about 70° C., with stirring (200 rpm) for about 1 hour, and then the rest of the Mixture A was pumped in for about 1 hr. When the addition was completed, a mixture of sodium persulfate (0.4 g) and sodium bicarbonate (0.76 g) in 20 g of water was added. The reactor was kept at about 70° C. for about 60 min. The reaction was continued for about 1 hr after the addition of 2 mL of 10% sodium bisulfate solution. This product had a Brookfield viscosity about 4000 cps.

### Example 14

### T-Butylacrylate/Acrylamide/Sodiumvinylsulfonate

Mixture A of t-butylacrylate (120 g, 0.94 mol), vinyl sulfonic acid sodium salt (4.3 g, 0.03 mol), acrylamide (20 g, 0.28 mol), allyl pentaerythrytyl ether (0.14 g, 0.001 mol), sodiumlauryl sulfate (4 g), and water (40 g) was prepared under nitrogen atmosphere and continuous stirring. Into a reactor, equipped with a stirrer, under nitrogen atmosphere, sodium laurylsulfate (1.4 g), Brij® 700 (11.2 g), sodium persulfate (2 g, 8 mmol), Mixture A (54 g) and water (515 g) were added. The reactor content was heated to about 70° C., with stirring (200 rpm) for about 1 hour. A solution of sodium persulfate (0.36 g), sodium bicarbonate (0.6 g) in 20 ml of water was added to the reactor. The rest of the Mixture A was pumped into the reaction mixture for about 1 hr. After another hour at 70° C. 2 mL of 10% sodium bisulfate solution was added. The reaction was continued for about 1 hr at 70° C. This product had a Brookfield viscosity about 1000 cps.

### Example 15

### T-Butylacrylate/Acrylamide/N,N′dimethylacrylamide/Sodiumvinylsulfonate

Mixture A of t-butylacrylate (120 g, 0.94 mol), vinyl sulfonic acid sodium salt (30 g, 0.23 mol), N,N′ dimethylacrylamide (40 g, 0.4 mol), acrylamide (15 g, 0.21 mol), allyl pentaerythrytyl ether (0.2 g,0.001 mol), Dowfax (5 g), and water (40 g) was prepared under nitrogen atmosphere and continuous stirring. Into a reactor, equipped with a stirrer, under nitrogen atmosphere, Dowfax (5 g), sodium persulfate (2 g, 8 mmol), Mixture A (54 g), ammonium sulfate (20 g) and water (580 g) were added. The reactor content was heated to about 70° C., with stirring (200 rpm) for about 1 hour. Then the rest of the Mixture A was pumped into the reaction mixture for about 1 hr. When the addition was completed, a mixture of sodium persulfate (0.4 g) and sodium bicarbonate (0.76 g) in 20 g of water was added. The reactor was kept at 70° C. for 60 min. The reaction was continued for 1 more hour after the addition of 2 mL of 10% sodium bisulfate solution. This product had a Brookfield viscosity of 50 cps.

### Example 16

### PVP/TBA (30/70 wt %)-Ethanol/t-Butanol

A solvent mixture of ethanol (30 g) and t-butanol (270 g) was prepared. Mixture A was prepared by mixing high purity N-Vinyl Pyrrolidone (HPVP, 30 g, 0.27 mol) and 100 g of the solvent mixture. Mixture B was prepared by mixing t-butyl-acrylate (TBA, 70 g, 0.55 mol) and 200 g of the solvent mixture. Mixture A was transferred into a reactor equipped with a stirrer, reflux condenser, nitrogen inlet and outlet. The reactor content was stirred at 200 rpm and heated up to about 65° C. (149° F.) with nitrogen purging. When the temperature reached at 65° C., 0.2 g Trigonox® 25C-75 (available from Akzo Nobel Polymer Chemicals) was added and Mixture B was pumped into the reactor over about two hours. Three shots of (0.2 g of each) Trigonox® 25C-75 were added into the reactor at each 2 hours. The reaction was continued for 2 more hours. The obtained product was clear viscous solution with Mw of 737,000 Daltons by SEC.

### Example 17

### PVP/TBA (60/40 wt %)-Ethanol/t-Butanol

A solvent mixture of ethanol (45 g) and t-butanol (255 g) was prepared. Mixture A was prepared by mixing N-Vinyl Pyrrolidone (HPVP, 60 g, 0.54 mol) and 200 g of the solvent mixture. Mixture B was prepared by mixing t-butyl-acrylate (TBA, 40 g, 0.31 mol) and 100 g of the solvent mixture. Mixture A was transferred into a reactor equipped with a stirrer, reflux condenser, nitrogen inlet and outlet. The reactor content was stirred at 200 rpm and heated up to about 70° C. with nitrogen purging. When temperature reached at 70° C., 0.2 g Trigonox® 25C-75 was added and Mixture B was pumped into the reactor over about two hours. Three shots of (0.2 g of each) Trigonox® 25C-75 were added into the reactor every 2 hours. The reaction was continued for about 2 more hours. The obtained product was a slightly hazy with Mw of 132,000 Daltons by SEC.

### Example 18

### PVP/TBA (50/50 wt %)

A solvent mixture was prepared by mixing water (45 g) and t-butanol (255 g). Mixture A was prepared by mixing N-Vinyl Pyrrolidone (HPVP, 50 g) and the solvent mixture (166.0 g). Mixture B (a feeding solution) was prepared by mixing t-butyl-acrylate (TBA, 50 g) and the solvent mixture (134.0 g). Mixture A was transferred into a reactor with a stirrer, reflux condenser, and nitrogen inlet and outlet. Reactor content was stirred at 200 rpm and heated to about 70° C. for about 1 hour under nitrogen. When temperature reached at 70° C., 1.0 g Trigonox® 25C-75 was added to the reactor and the feeding solution was pumped into the reactor over about two hour period of time. After 2 hours, three shots of Trigonox® 25C-75 (0.2 g for each) were added. The reaction was continued for two more hours and then cooled to about 50° C. (122° F.). The obtained product was a slightly hazy solution with a Brookfield viscosity of 5,000 cps. The average molecular weight was 127,000 Daltons.

### Example 19

### PVP/TBA (30/70 wt %)-Ethanol

Mixture A was prepared by mixing N-Vinyl Pyrrolidone (HPVP, 30 g, 0.27 mol) and ethanol (100 g). Mixture B was prepared by mixing t-butyl-acrylate (TBA, 70 g, 0.55 mol) and ethanol (200 g). Mixture A was transferred into a reactor equipped with a mechanic stirrer, reflux condenser, and nitrogen inlet and outlet. The reactor content was heated to about 65° C. with stirring at 200 rpm and nitrogen purging. When the temperature reached at 65° C., 0.2 g Trigonox® 25C-75 was added into the reactor and Mixture B was fed into the reactor over two hours period of time. Three shots of (0.2 g of each) Trigonox® 25C-75 were added into the reactor at each 2 hours. The reaction was continued for 2 more hours. Then the reaction was stopped and the contents of the reactor were discharged into a glass jar. The obtained product was a clear viscous solution with Brookfield viscosity of 2,000 cps. The Mw by SEC was 25,600 Daltons.

### Example 20

### PVP/TBA (30/70 wt %)-Ethanol

Mixture A was prepared by mixing N-Vinyl Pyrrolidone (HPVP, 30 g, 0.27 mol) and ethanol (60 g). Mixture B was prepared by mixing t-butyl-acrylate (TBA, 70 g, 0.55 mol) and ethanol (240 g). Mixture A was transferred into a reactor equipped with a mechanic stirrer, reflux condenser, nitrogen inlet and outlet. The reactor content was heated to about 65° C. with stirring at 200 rpm and nitrogen purging. When the temperature reached at 65° C., 0.4 g Trigonox25C-75 was added into the reactor and Mixture B was pumped into the reactor over two hours period of time. Two shots of (0.2 g of each) Trigonox25C-75 were added into the reactor at each 2 hours. The reaction was continued for 2 more hours. Then the reaction was stopped and the contents of the reactor were charged into a glass jar. The obtained product was a clear viscous solution with a Brookfield viscosity of 2,000 cps. The Mw by SEC was 146,000 Dalton.

### Example 21

### PVP/TBA (30/70 wt %)-Water/t-Butanol

A solvent mixture was prepared by mixing water (45 g) and t-butanol (255 g). Mixture A was prepared by mixing N-Vinyl Pyrrolidone (HPVP, 30 g, 0.27 mol) and 100 g of the solvent mixture. A feeding solution was prepared by mixing t-butyl-acrylate (TBA, 70 g, 0.55 mol) and the solvent mixture (200 g). Mixture A was transferred into a reactor equipped with a stirrer, reflux condenser, nitrogen inlet and outlet. The reactor content was stirred at 200 rpm and heated to about 65° C. over one hour under nitrogen. When the temperature reached at 65° C., 1.0 g Trigonox® 25C-75 was added and the feeding solution was pumped into the reactor over two hour period. Three shots (0.2 g each) of Trigonox®25C-75 were added into the reactor every two hours. The reaction was continued for two more hours and then cooled to about 50° C. The contents of the reactor were discharged. The obtained product was a clear viscous solution having Mw of 1,120,000 Daltons by SEC. The Brookfield viscosity was 1853,000 cps.

### Example 22

### PVP/TBA (30/70 wt %)-Water/t-Butanol

A solvent mixture was prepared by mixing water (45 g) and t-butanol (255 g). Mixture A was prepared by mixing N-Vinyl Pyrrolidone (HPVP, 30 g, 0.27 mol) and 100 g of the solvent mixture. A feeding solution B was prepared by mixing t-butyl-acrylate (TBA, 70 g, 0.55 mol) and the solvent mixture (200 g). Mixture A was transferred into a reactor equipped with a stirrer, reflux condenser, and nitrogen inlet and outlet. The reactor content was stirred at 200 rpm and heated to about 75° C. over one hour under nitrogen. When the temperature reached at 75° C., 1.0 g Trigonox® 25C-75 was added and the feeding solution B was pumped into the reactor over two hour period. Three shots (0.2 g each) of Trigonox® 25C-75 were added into the reactor every two hours. The reaction was continued for two more hours and then cooled to about 50° C. The contents of the reactor were discharged. The obtained product had a Brookfield viscosity of 6000 cPs and Mw of 341,000 Daltons by SEC.

### Example 23

### PVP/TBA (30/70 wt %)-Water/t-Butanol

A solvent mixture was prepared by mixing water (45 g) and t-butanol (255 g). Mixture A was prepared by mixing N-Vinyl Pyrrolidone (HPVP, 30 g, 0.27 mol) and 100 g of the solvent mixture. A feeding solution B was prepared by mixing t-butyl-acrylate (TBA, 70 g, 0.55 mol) and the solvent mixture (200 g). Mixture A was transferred into a reactor equipped with a stirrer, reflux condenser, and nitrogen inlet and outlet. The reactor content was stirred at 200 rpm and heated to about 70° C. over one hour under nitrogen. When the temperature reached at 70° C., 1.0 g Trigonox® 25C-75 was added and the feeding solution B was pumped into the reactor over two hour period of time. Three shots (0.2 g each) of Trigonox® 25C-75 were added into the reactor at each two hours. The reaction was continued for two more hours and then cooled to about 50° C. The contents of the reactor were discharged. The obtained product had Mw of 107,000 Daltons by SEC and the Brookfield viscosity was 2, 200 cps.

### Example 24

### PVP/TBA (30/70 wt %)-Water/t-Butanol

A solvent mixture was prepared by mixing water (35 g) and t-butanol (198 g). Mixture A was prepared by mixing N-Vinyl Pyrrolidone (HPVP, 30 g, 0.27 mol) and the solvent mixture (100 g). A feeding solution B was prepared by mixing t-butyl-acrylate (TBA, 70 g, 0.55 mol) and the solvent mixture (133 g). Mixture A was transferred into a reactor equipped with a stirrer, reflux condenser, and nitrogen inlet and outlet. The reactor content was stirred at 200 rpm and heated to about 65° C. over one hour under nitrogen. When temperature reached at 65° C., 1.0 g Trigonox® 25C-75 was added and the feeding solution B was pumped into the reactor over two hour period. Three shots (0.2 g each) of Trigonox® 25C-75 were added into the reactor at each two hours. The reaction was continued for two more hours and then cooled to about 50° C. The contents of the reactor were discharged. The obtained product had a Brookfield viscosity of 8,000 cps.

### Example 25

### PVP/TBA (40/60 wt %)-Water/t-Butanol

A solvent mixture was prepared by mixing water (45 g) and t-butanol (255 g). Mixture A was prepared by mixing N-Vinyl Pyrrolidone (HPVP, 40 g) and the solvent mixture (133.0 g). Mixture B (a feeding solution) was prepared by mixing t-butyl-acrylate (TBA, 60 g) and the solvent mixture (167.0 g). Mixture A was transferred into a reactor with a stirrer, reflux condenser, and nitrogen inlet and outlet. Reactor contents were stirred at 200 rpm and heated to about 70° C. for about 1 hour under nitrogen. When the temperature reached at 70° C., 1.0 g Trigonox® 25C-75 was added to the reactor and the feeding solution B was pumped into the reactor over two hour period of time. After 2 hours, three shots of Trigonox® 25C-75 (0.2 g for each) were added. The reaction was continued for two more hours and then cooled to about 50° C. The obtained product had a Brookfield viscosity of 5,000 cps.

### Example 26

### PVP/TBA (60/40 wt %)-Water/t-Butanol

A solvent mixture was prepared by mixing water (45 g) and t-butanol (255 g). Mixture A was prepared by mixing N-Vinyl Pyrrolidone (HPVP, 60 g, 0.54 mol) and the solvent mixture (300.0 g). Mixture A was transferred into a reactor with a stirrer, reflux condenser, and nitrogen inlet and outlet. Reactor contents were stirred at 200 rpm and heated to about 70° C. for about 1 hour under nitrogen. When the temperature reached at 70° C., 1.0 g Trigonox® 25C-75 was added to the reactor and tert-butyl acrylate (40 g) was pumped into the reactor over two hour period. After 2 hours, three shots of Trigonox® 25C-75 (0.2 g for each) were added. The reaction was continued for two more hours and then cooled to about 50° C. The obtained product was a slightly hazy solution with Mw of 151,000 Daltons by SEC. The Brookfield viscosity was around 7,000 cps at room temperature.

### Cement Anti-Settling Test

### Cement Components

TABLE 1
List of Components for Cement Test

| | Composition, wt % (by |
|---|---|
| | weight of cement, bwoc) |
| Class H Cement (powder) | |
| Silica Flour (powder) | 35 |
| XxtraDura ™ FLA 3767 (powder)* | 0.8 |
| Synthetic Retarder** (powder or liquid) | 1.6 |
| Suspending Agent | 0.7 (active) |

*A commercial product, available from Ashland Inc.
**Mixture of FRITZ PCR-3 and FRITZ PCR-4 with weight ratio of 1:1. FRITZ PCR-3 and FRITZ PCR-4 are available from Fritz Industries, Inc.

Class H cements powder and silica flour powder were used as received without any treatment. XxtraDura™ FLA 3766 was used as two-in-one (high temperature fluid loss control additive and surface control additive). Commercially available high temperature synthetic retarder of FRITZ PCR-3 and FRITZ PCR-4 were used for set control.

### Cement Slurry Preparation

Cement, silica flour and other solid or powder components in Table 1 were weighed and dry-mixed well to form a dry component in a container. Suspending agent (in liquid) and water were weighed in a Waring blender cup. Cement slurries were prepared following API (American Petroleum Institute) Recommended Practice 10B-2. The dry component was added into the Waring blender cup with the suspending agent and water to form a mixture. The mixture was agitated under 4000 rpm for about 15 seconds. Then, the agitation speed was increased to about 12000 rpm for about 35 seconds to form a cement slurry. In the tests, the cement slurry was designed to have a density about 16.4 ppg (pounds per gallon).

Cement Rheology at 88° C. after Conditioning at 190° C.

Initial cement slurry anti-settling performance was evaluated through observing cement slurry settling in Fann® 35 viscometer cup and High Pressure, High Temperature (HPHT) consistometer cell at 88° C. after conditioning at 190° C.

First, cement was conditioned using a High Pressure, High Temperature (HPHT) consistometer (Chandler Engineering® Model 8240 Consistometer) for about 30 minutes at about 190° C. The heating schedule was set from room temperature to 190° C. for 50 minutes. After conditioning, the cement was cooled down to 88° C. under agitation and then was transferred to Fann® 35 viscometer. Steady shear stresses (direct readings from the viscometer) at multiple rotational rates, 300, 200, 100, 6, 3 rpm, were recorded and shown in Table 2.

TABLE 2
Cement Rheology at 190° F. after Conditioning at 375° F.

| | | DR | DR | DR | DR | DR | Ob- |
|---|---|---|---|---|---|---|---|
| | | 300 | 200 | 100 | 6 | 3 | serva- |
| Sample | Loading | RPM | RPM | RPM | RPM | RPM | tion |
| Example 13 | 0.7% bwoc | 230 | 137 | 99 | 19 | 17 | No |
| | | | | | | | settling |
| Example 14 | 0.7% bwoc | 400 | 304 | 180 | 17 | 11 | No |
| | | | | | | | settling |
| Example 12 | 0.7% bwoc | 138 | 88 | 40 | 2 | 2 | Settling |
| Example 16 | 0.7% bwoc | 242 | 168 | 89 | 6 | 3 | Settling |
| Example 18 | 0.7% bwoc | 467 | 328 | 182 | 14 | 8 | Slight |
| | | | | | | | settling |
| Example 17 | 0.7% bwoc | 488 | 344 | 210 | 35 | 29 | No |
| | | | | | | | settling |

### BP Anti-Settling Tests

Cement slurry anti-settling performance was checked and confirmed through BP settling tests with a test cell of 25 mm inner diameter and 200 mm length (see below for test procedure in details).

Slurry Precondition
a. Ramp temperature to 190° C. for 60 minutes
b. Hold temperature at 190° C. for 20 minutes
c. Cool to 88° C. and pull immediately

BP Settling Test
a. Preheat the curing chamber to 88° C. while the slurry was preconditioning
b. Load the prepared cylinder molds into the curing chamber
c. Seal the curing chamber
d. Ramp the temperature from 88° C. to 190° C. for 40 minutes (190° C. of final temperature and 3000 psi of final pressure)
e. Allow the slurry to set for 24 hours.

Top-Middle-Bottom (TMB) Density Gradient Measurements
a. Cool the samples to 88° C. after the 24 hours set time and pull from the curing chamber.
b. Remove the set cement samples from the cylinder molds.
c. Mark the cement sample 3/4″ from the bottom and 3/4″ from the top. Cut the section between these two marks into 3 equal parts.
d. Measure the density of the 3 cut parts using Archimedes Principle

The cement testing results are shown in Table 3.

TABLE 3
BP Settling Test Results

| Sample | Loading | T-to-B Density Variation |
|---|---|---|
| Example 13 | 0.7% bwoc | 2.25% |
| Example 14 | 0.7% bwoc | 3.10% |
| Example 12 | 0.7% bwoc | 31.60% |
| Example 16 | 0.7% bwoc | 14.80% |
| Example 17 | 0.7% bwoc | 1.80% |

All references including patent applications and publication cited herein are incorporated herein by reference in their entirety and for all purpose to the same extent as if each individual publication or patent or patent application was specifically and individually indicated to be incorporated by reference in its entirety for all purposes. Many modifications and variations of the presently disclosed and/or claimed inventive concept(s) can be made without departing from its spirit and scope, as will be apparent to those skilled in the art. The specific embodiments described herein are offered by way of example only, and the presently disclosed and/or claimed inventive concept9s) is to be limited only by the terms of the appended claims, along with the full scope of equivalents to which such claims are entitled.

1-36. (canceled)

37. A cementing fluid comprising:
an aqueous fluid;
a hydraulically-active cementitous material; and
a suspending agent,
wherein the suspending agent is a hydrophobic copolymer having a weight average molecular weight greater than 100,000 Daltons, and the hydrophobic copolymer is obtained by solution copolymerizing a reaction mixture of an alkyl (meth)acrylate and an ethylenically unsaturated monomer.

38. A cementing fluid comprising:
an aqueous fluid;
a hydraulically-active cementitous material; and
a suspending agent,
wherein the suspending agent is a cross-linked hydrophobic copolymer particulate, and the cross-linked hydrophobic copolymer particulate is obtained by emulsion copolymerizing a reaction mixture of an alkyl (meth)acrylate and an ethylenically unsaturated monomer in the presence of an emulsifier and cross-linking the hydrophobic copolymer with a cross-linker.

39. The cementing fluid of claim 37, wherein the alkyl (meth)acrylate comprises an alkyl group having 1 to about 22 carbon atoms.

40. The cementing fluid of claim 38, wherein the alkyl (meth)acrylate comprises an alkyl group having 1 to about 22 carbon atoms.

41. The cementing fluid of claim 39, wherein the alkyl (meth)acrylate is selected from the group consisting of t-butyl (meth)acrylate, iso-butyl (meth)acrylate, hexyl (meth)acrylate, isonornornyl (meth)acrylate, and combinations thereof.

42. The cementing fluid of claim 40, wherein the alkyl (meth)acrylate is selected from the group consisting of t-butyl (meth)acrylate, iso-butyl (meth)acrylate, hexyl (meth)acrylate, isonornornyl (meth)acrylate, and combinations thereof.

43. The cementing fluid of claim 37, wherein the ethylenically unsaturated monomer is selected from the group consisting of acrylamide, N,N′-dimethyl acrylamide, vinyl sulfonate, vinyl pyrrolidone, vinyl acetate, vinyl benzene, styrene, styrene sulfonate, ally-2-hydroxypropane sulfonate, vinyl acetate, vinyl propionate, and combinations thereof.

44. The cementing fluid of claim 38, wherein the ethylenically unsaturated monomer is selected from the group consisting of acrylamide, N,N′-dimethyl acrylamide, vinyl sulfonate, vinyl pyrrolidone, vinyl acetate, vinyl benzene, styrene, styrene sulfonate, ally-2-hydroxypropane sulfonate, vinyl acetate, vinyl propionate, and combinations thereof.

45. The cementing fluid of claim 38, wherein the cross-linker is selected from a group consisting of diallyl pentaerythrytyl ether, triallyl pentaerythrityl ether, tetraallyl pentaerythrytyl ether, N,N′ methlenebis acrylamide, and combinations thereof.

46. The cementing fluid of claim 38, wherein the emulsifier is an ionic emulsifier.

47. The cementing fluid of claim 46, wherein the ionic emulsifier is an anionic emulsifier.

48. The cementing fluid of claim 38, wherein the cross-linked hydrophobic copolymer particulate has a weight average molecular weight of above 100,000 Daltons.

49. The cementing fluid of claim 37, wherein the cementitous material is slag, hydraulic cement or a mixture thereof.

50. The cementing fluid of claim 38, wherein the cementitous material is slag, hydraulic cement or a mixture thereof.

51. The cementing fluid of claim 49, wherein the cementitous material comprises Portland cement.

52. The cementing fluid of claim 50, wherein the cementitous material comprises Portland cement.

53. A method of cementing within a subterranean formation for an oil or gas well, comprising:
formulating a cementing fluid by mixing an aqueous fluid, a hydraulically-active cementitous material and a suspending agent;
pumping the cementing fluid onto the subterranean formation; and
allowing the cementing fluid to set,
wherein the suspending agent is a hydrophobic copolymer having a weight average molecular weight of greater than 100,000 Daltons.

54. A method of cementing within a subterranean formation for an oil or gas well, comprising:
formulating a cementing fluid by mixing an aqueous fluid, a hydraulically-active cementitous material and a suspending agent;
pumping the cementing fluid onto the subterranean formation; and
allowing the cementing fluid to set,
wherein the suspending agent is a cross-linked hydrophobic copolymer particulate.

55. The method of claim 53, wherein the hydrophobic copolymer is obtained by solution copolymerizing a reaction mixture of an alkyl (meth)acrylate and an ethylenically unsaturated monomer.

56. The method of claim 54, wherein the cross-linked hydrophobic copolymer particulate is obtained by emulsion copolymerizing a reaction mixture of an alkyl (meth)acrylate and an ethylenically unsaturated monomer in the presence of an emulsifier and cross-linking the hydrophobic copolymer with a cross-linker.
